(19) United States
(12) Patent Application Publication
(10) Pub. No.: US 2002/0071745 A1
(43) Pub. Date: Jun. 13, 2002

(54) Apparatus and method for grasping and transporting wafers

(76) Inventors: Robert Mainberger, Braunfels (DE); Kurt Hahn, Geissen (DE)

Correspondence Address: Glenn Law, FOLEY & LARDNER, Washington Harbour, 3000 K Street, N.W., Suite 500, Washington, DC, 20007-5143, US

(21) Appl. No.: 10/012,028

(22) Filed: Dec. 11, 2001

(30) Foreign Application Priority Data
Dec. 11, 2000 (DE) 100 61 628.3-22

(51) Int. Cl. B65G 49/07

(52) U.S. Cl. 414/217

(57) ABSTRACT

The invention concerns an apparatus for grasping and transporting wafers (1), having a two-armed grasping apparatus (7), pivotable about a central rotation point (13), at whose two free ends grasping/retaining elements (12) equipped with vacuum suction devices (11) are arranged. In order to make available an apparatus of the kind cited initially, as well as a transport arrangement equipped with such an apparatus, that make possible faster transport of the wafers (1) without long dead times and thus permit an increase in overall throughput, it is proposed according to the present invention that the two arms (10) of the grasping apparatus (7) be angled with respect to one another at an angle (α) 90°<α<180°. The invention furthermore concerns a complete transport arrangement equipped with such an apparatus, as well as a method for operating said transport arrangement.

### CROSS REFERENCE TO RELATED APPLICATIONS

This invention claims priority of the German patent application 100 61 628.3-22 which is incorporated by reference herein.

### FIELD OF THE INVENTION

The invention concerns an apparatus for grasping and transporting wafers, having a two-armed grasping apparatus, pivotable about a central rotation point, at whose two free ends grasping/retaining elements equipped with vacuum suction devices are arranged. The invention further concerns a complete transport arrangement equipped with such an apparatus, and a method for operating said transport arrangement.

### BACKGROUND OF THE INVENTION

In microelectronics, single-crystal semiconductor disks called “wafers” are used for chip manufacturing using solid state technology. On these wafers, manufactured under ultra-clean-room conditions, a plurality of integrated circuits are produced. In order to transport the wafers during production and testing from one storage or processing position to the next, they are stored in cassettes. Grasping apparatuses equipped with vacuum suction devices are generally used to remove the wafers from the cassettes. The grasping apparatuses set the particular wafers that have been removed onto placement positions for further handling.

In the wafer transport apparatuses known from practical use, two-armed grasping apparatuses (also called “wafer handlers”) that are pivotable about a central rotation point are used to transport the wafers between each two placement positions. The two arms of these known grasping apparatuses are arranged about the rotation point at a 180° offset from one another, i.e. they lie on one axis. Grasping/retaining elements having vacuum suction devices are arranged at the two free ends of the arms. A grasping apparatus of this kind is known, for example, from U.S. Pat. No. 5,229,615.

In order to grasp a wafer and move it to another placement position, and/or subsequently, with the other end of the grasping apparatus, to remove another wafer from the same placement position, it is necessary in each case to pivot the grasping apparatus 180°. This large pivot angle, as well as the dead times occurring during transport in which the grasping apparatus is stationary because there is no wafer available to be grasped, mean an expensive loss of time during chip manufacture.

### SUMMARY OF THE INVENTION

Proceeding from this existing art, it is therefore an object of the invention to make available an apparatus of the kind cited initially, as well as a transport arrangement equipped with such an apparatus, that make possible faster transport of the wafers without long dead times, and thus an increase in the overall throughput of the arrangement. A further object of the invention is to make available a method for operating said transport arrangement.

In terms of apparatus, the stated object is achieved according to the present invention by the fact that the two arms of the wafer handler are angled with respect to one another at an angle 90°<α<180°.

The decrease according to the present invention in the angle extending between the two arms of the grasping apparatus makes it possible greatly to reduce the displacement time for grasping the next wafer. It is particularly advantageous in this context if the angle extending between the arms is configured such that said angle also reappears in the arrangement of the pickup and placement positions for the wafers. It is thus sufficient, in every case, to pivot the grasping apparatus by no more than the angular magnitude that corresponds to the angle extending between the two arms.

According to a first practical embodiment of the invention, the angle between the two arms of the grasping apparatus equals 120°. The use of the 120° angle is particularly advantageous because with this angular position, a transport arrangement having three placement or pickup positions for the wafers can be used, the individual placement or pickup positions each being arranged at a 120° offset from one another so that two of the three placement or storage positions are always reachable simultaneously by means of the grasping apparatus.

With this embodiment, the grasping apparatus is pivotable back and forth about the rotation point a maximum of 2×120° between two excursion positions. Pivoting the grasping apparatus through 2×120° yields the capability of activating three placement or pickup positions.

According to a second practical embodiment of the invention, the angle between the two arms of the grasping apparatus equals 135°. With this embodiment, the grasping apparatus is pivotable back and forth about the rotation point a maximum of 135° between two excursion positions. Starting from a neutral position of the grasping apparatus, it is possible to limit the maximum pivot range of the grasping apparatus about the rotation point to a maximum of ½×135° in each direction, so that the next placement or pickup position is reachable after only a very short pivoting time.

The invention furthermore proposes that the end points of the respective pivot range of the grasping apparatus be bounded by stops.

Of course it is also possible in an apparatus configured according to the present invention for the grasping apparatus to be pivotable in unlimited fashion about the rotation point. In this case stops for limiting the pivoting motion are entirely omitted.

A transport arrangement according to the present invention for transporting wafers between two stations, in particular between a wafer magazine and a testing apparatus, having at least one wafer storage station, a robot arm for unloading and/or loading the wafer storage station, a holding area for the wafers, a wafer processing station, and a grasping apparatus for transporting the wafers from the holding area to the wafer processing station and back, is characterized, in order to achieve the stated object, by a second holding area between the wafer storage station and the wafer processing station, the one holding area serving as a depository for transport to the wafer processing station, and the other holding area serving as depository for transport back from the wafer processing station.

The use of two holding areas makes it possible greatly to increase the throughput attainable with the transport arrangement, since dead times for the grasping apparatus and the robot arm are reduced.

According to a preferred embodiment of the invention, the holding area serving for transport to the wafer processing station is configured as a pre-alignment station, where a first alignment of the wafer takes place before the latter is delivered by means of the grasping apparatus to a wafer processing station. The latter can be configured, for example, as a microscope having an X-Y stage, or as a coordinating measuring instrument, or as a pattern width measuring instrument.

In order to reduce to a minimum the pivot angle of the grasping apparatus for picking up wafers from or placing wafers into the holding area, it is proposed according to the present invention that the two holding areas be arranged relative to the rotation point of the grasping apparatus at an angle α defined by the two arms of the grasping apparatus, and on a pivot circle defined by the ends of the two arms.

The method according to the present invention for transporting wafers between two stations, in particular between a wafer magazine and a testing apparatus, by means of a transport arrangement according to the present invention having at least one wafer storage station, a robot arm for unloading and/or loading the wafer storage station, a holding area for the wafers, a wafer processing station, and a grasping apparatus for transporting the wafers from the holding area to the wafer processing station and back, is characterized by the method steps of:

1. removing a first wafer from a wafer storage station and placing said first wafer on the first holding area by means of the robot arm;

2. grasping the first wafer present on the first holding area by means of the grasping apparatus and transferring said first wafer to the wafer processing station, and pivoting the grasping apparatus into a neutral position while removal of a second wafer from the wafer storage station is simultaneously accomplished;

3. placing the second wafer on the first holding area (once again unoccupied) by means of the robot arm;

4. moving the robot arm into a parked position beneath the second holding area and simultaneously grasping the first wafer placed on the wafer processing station and the second wafer placed on the first holding area by means of the grasping apparatus;

5. placing the first wafer on the second holding area and placing the second wafer on the wafer processing station;

6. pivoting the grasping apparatus into a neutral position;

7. grasping the first wafer that was placed on the second holding area, by raising the robot arm parked beneath the second holding area; and

8. placing in the wafer storage station the first wafer picked up from the second holding area.

The use of the second holding area and the parking of the robot arm beneath the second holding area, instead of in the region of the wafer storage station as is known from the existing art, saves time on the order of seconds especially in the eighth method step, resulting in an increase of more than 10% in the throughput achievable with this transport arrangement.

Lastly, it is proposed with the method according to the present invention that when the first holding area is configured as a pre-alignment station, a pre-alignment of the wafers placed on the first holding area be accomplished simultaneously after the first method steps [sic] and/or during the fourth method step. The times for pre-alignment thus become part of the times expended in any case for the aforesaid method steps, and do not accrue as machine operation times. The method according to the present invention can thereby be used even more effectively.

### BRIEF DESCRIPTION OF THE DRAWINGS

Further features and advantages of the invention are evident from the description below of the accompanying drawings, in which two exemplary embodiments of a transport arrangement according to the present invention are schematically depicted by way of example. In the drawings:

FIG. 1 shows a plan view of a first embodiment of a transport arrangement according to the present invention;

FIG. 2 shows a plan view of a second embodiment of a transport arrangement according to the present invention;

FIG. 3 schematically depicts the grasping apparatus in the neutral position;

FIG. 4 schematically depicts the grasping apparatus in engagement with the first holding area;

FIG. 5 schematically depicts the grasping apparatus in engagement with the second holding area; and

FIGS. 6a-6i depict method steps performed by the transport arrangement.

### DETAILED DESCRIPTION OF THE INVENTION

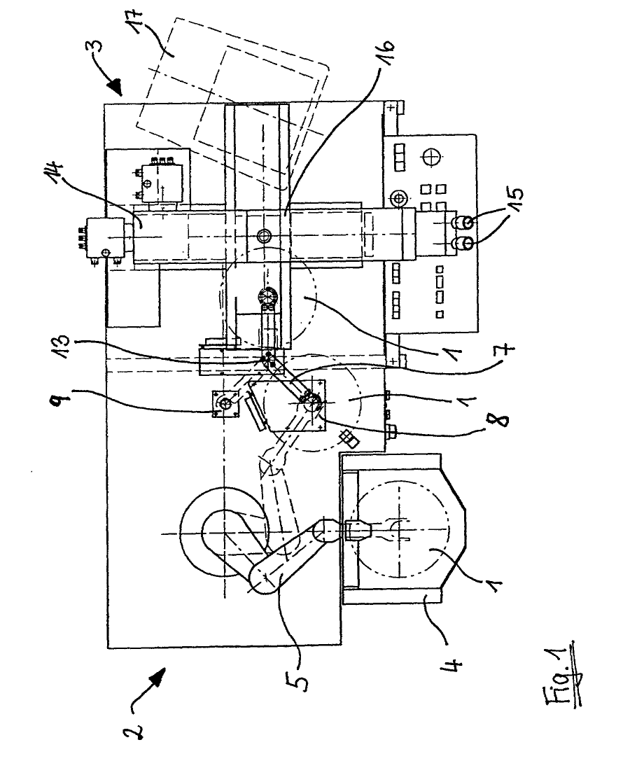

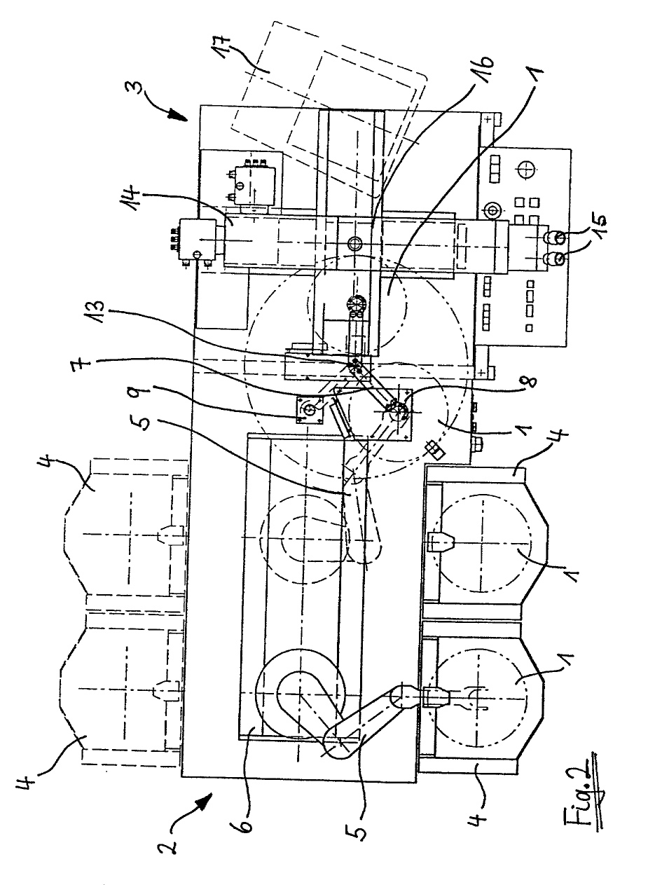

FIGS. 1 and 2 show plan views of transport arrangements for transporting wafers 1 from a wafer storage station 2 to a wafer processing station 3 and back. The two transport arrangements depicted differ in that wafer storage station 2 shown in FIG. 1 comprises one magazine 4 for the storage of wafers 1, whereas wafer storage station 2 shown in FIG. 2 is equipped with four magazines 4. In order to be able to reach all magazines 4 by means of one robot arm 5 for loading and unloading wafers, robot arm 5 of the transport arrangement shown in FIG. 2 is additionally movable along a guide 6 extending between magazines 4.

In addition to the use of robot arm 5 for loading and unloading magazine or magazines 4 of wafer storage station 2, transport of wafers 1 to wafer processing station 3 and back again is accomplished using a grasping apparatus 7 and two holding areas 8 and 9 arranged between wafer storage station 2 and wafer processing station 3, first holding area 8 being used for the transport of wafers 1 to wafer processing station 3, and second holding area being used for the transport of wafers 1 away from wafer processing station 3.

In the example depicted here, wafer processing station 3 comprises a microscope 14 having eyepieces 15 and a microscope stage 16 for placement of a wafer 1 to be examined. The microscope image is additionally acquired by means of a video camera (not depicted) and displayed on a monitor 17.

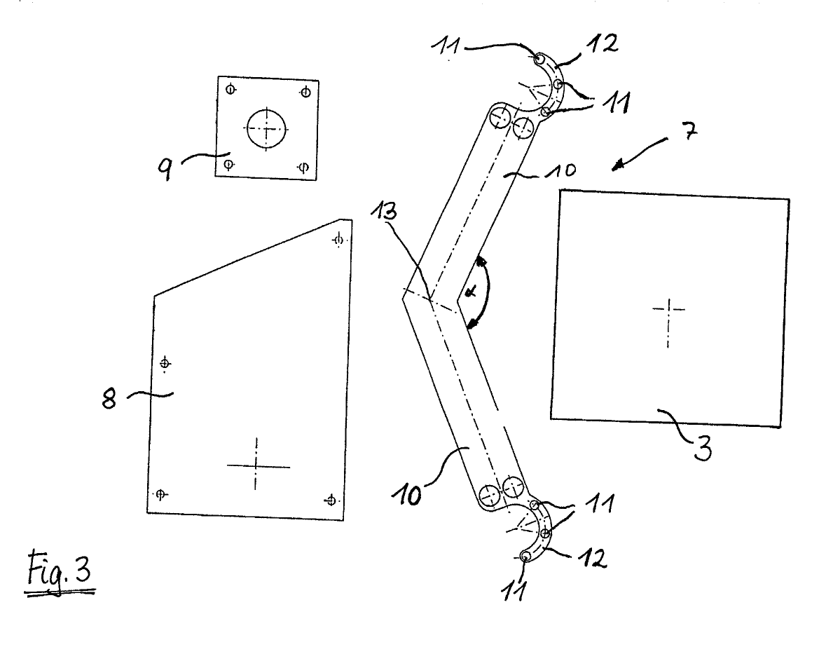

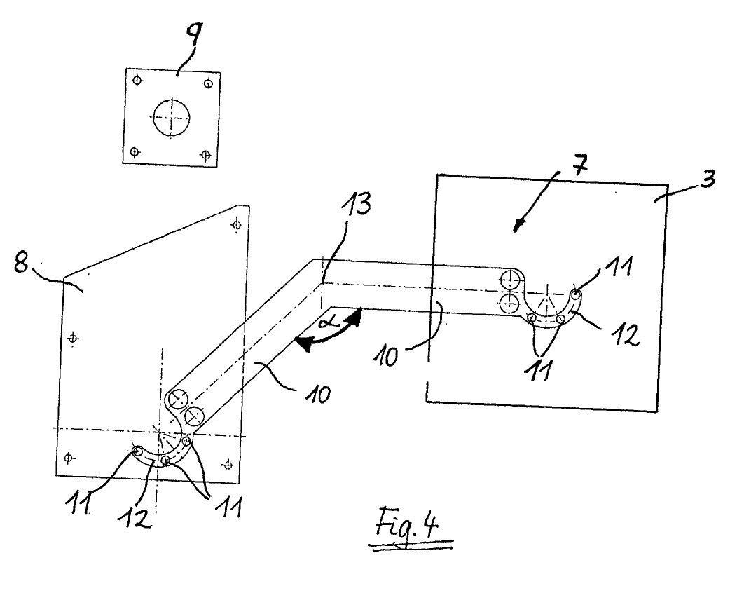

The construction and mode of operation of grasping apparatus 7 are evident in more detail from FIGS. 3, 4, 5, and 6a-6i.

Grasping apparatus 7 has two arms 10 that enclose between them an angle α of 90°<α<180°. At the two free ends, arms 10 have grasping/retaining elements 12, equipped with vacuum suction devices 11, with which wafers 1 that are to be transported can be grasped. For transporting wafers 1 from holding area 8 and to holding area 9, grasping apparatus 7 is pivotable about a central rotation point 13.

Transportation of wafers 1 from wafer storage station 2 to wafer processing station 3 and back again is performed, with the transport arrangement depicted, as described below.

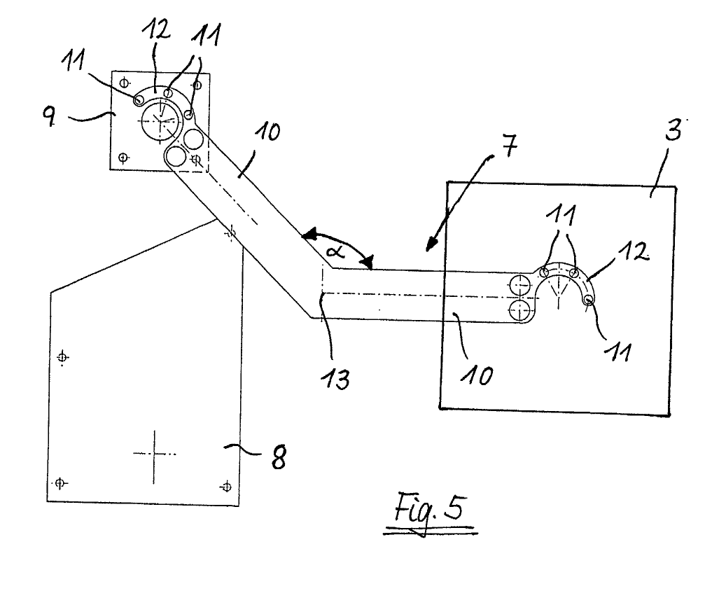

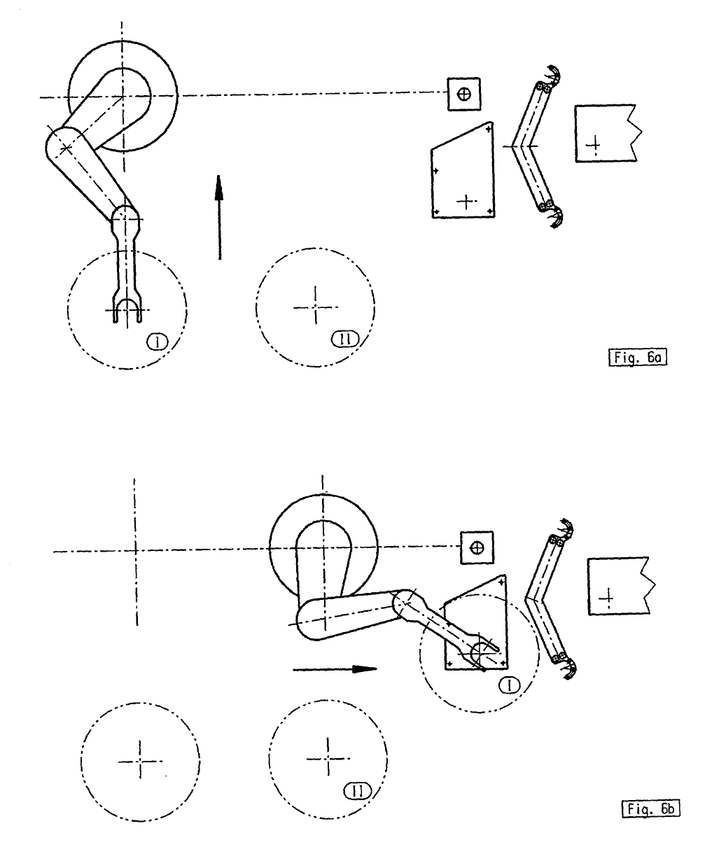

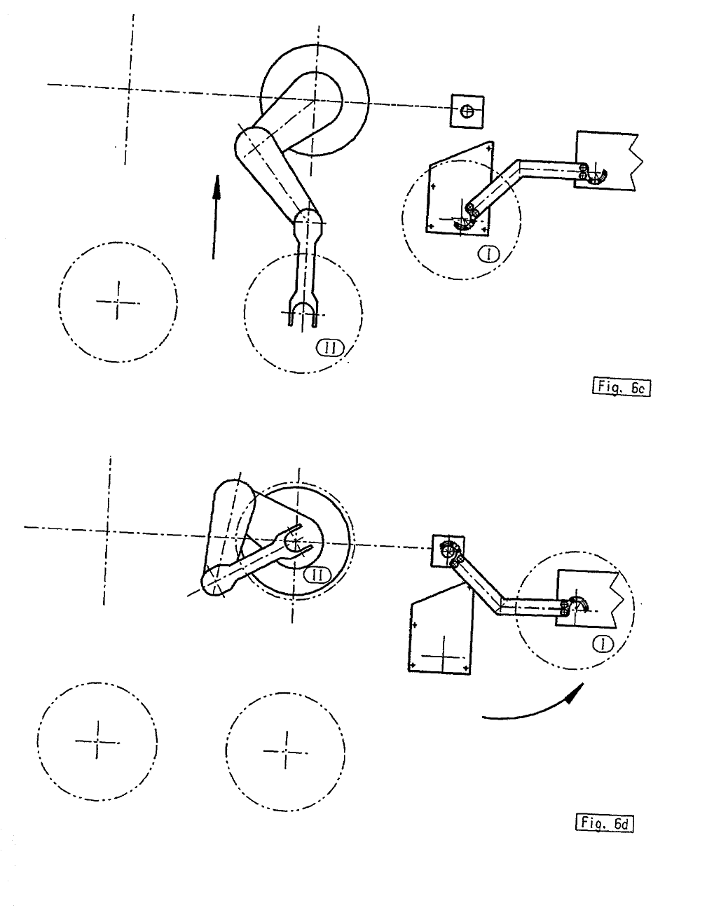

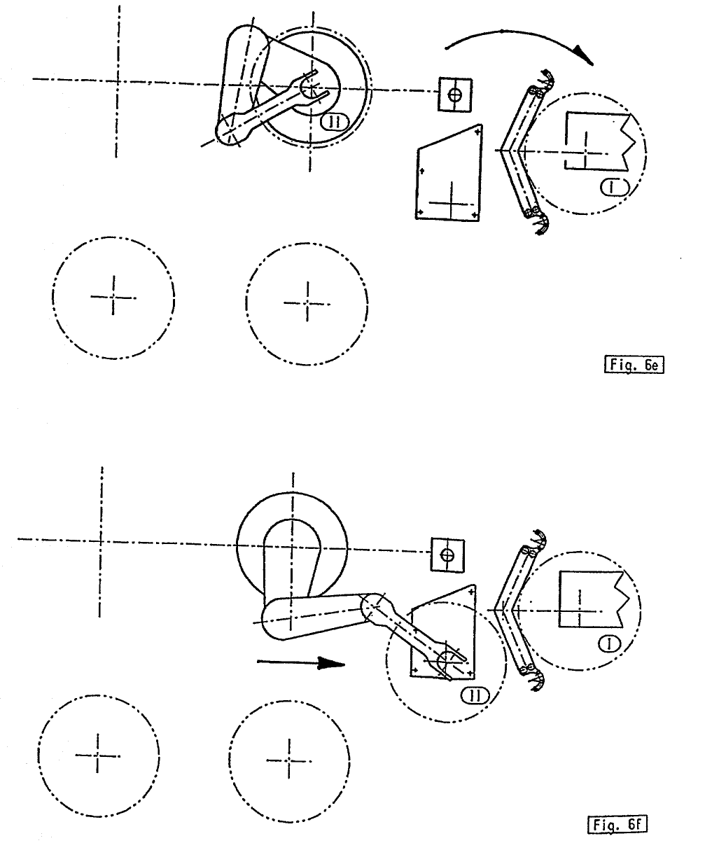

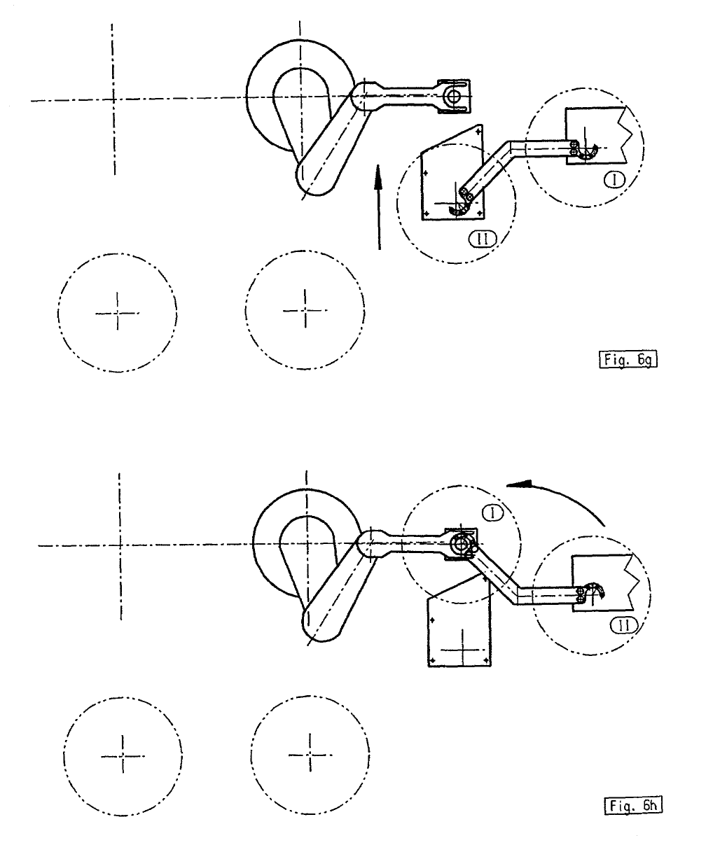

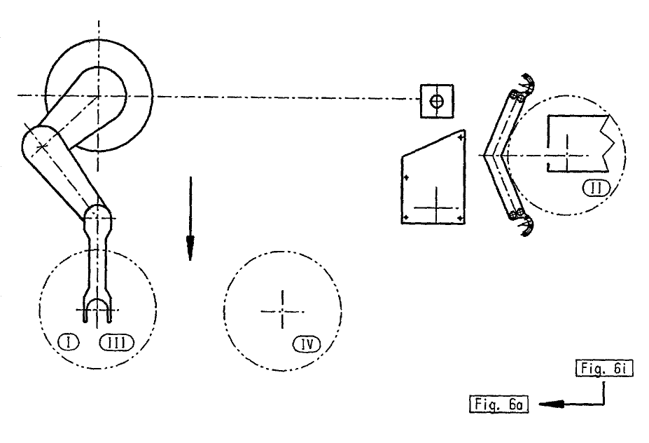

Before the first method step begins, grasping apparatus 7 is in the neutral position depicted in FIG. 3. The position of the entire transport arrangement before the first method step is shown in FIG. 6a.

In the first method step, robot arm 5 removes a wafer I from a magazine 4 of wafer storage station 2 and places it on first holding area 8. In the case of the transport arrangement shown in FIG. 2 it may be necessary, for the removal of first wafer I from magazine 4, for robot arm 5 first to move along guide 6 until it has reached the corresponding magazine 4. Similarly, after the removal of first wafer I it is then necessary to move robot arm 5 again in the direction of holding areas 8, 9 so that first wafer I can be placed. This method step is illustrated in FIGS. 6a and 6b.

In a second method step, first wafer I present on first holding area 8 is grasped with a grasping/retaining element 12 of grasping apparatus 7, as depicted in FIG. 6c. After rotation of grasping apparatus 7 through angle α in the direction of wafer processing station 3, first wafer I is placed on said wafer processing station 3. The position of grasping apparatus 7 upon placement of first wafer I on wafer processing station 3 is depicted in FIG. 6d. After that grasping apparatus 7 is pivoted into the neutral position, as depicted in FIG. 6e.

First wafer I can now be checked, measured, or otherwise processed on wafer processing station 3. Wafer processing station 3 can be, for example, a microscope 14 for measuring and inspecting the integrated circuits of first wafer I. In such a case it is advantageous if first holding area 8 is configured as a pre-alignment station in order to prepare wafer I (and respective wafers later placed on it) for exact placement on the X-Y stage.

During grasping and placement of first wafer I, a second wafer II is taken from wafer storage station 2 with robot arm 5, as shown in FIG. 6c.

In a third method step, second wafer II that has been picked up is placed by means of robot arm 5 on first holding area 8 (now once again unoccupied), while grasping apparatus 7 stays in the neutral position, as depicted in FIG. 6f.

Robot arm 5 is then moved into a parked position beneath the second (and still unoccupied) holding area 9, as shown in FIG. 6g. The robot arm is thus located outside the pivot range of grasping apparatus 7 in order to prevent collisions.

In a fourth method step, grasping apparatus 7 is pivoted out of the neutral position depicted in FIG. 6e into the position depicted in FIG. 6g, and raised in that position. Simultaneously, first wafer I present on wafer processing station 3 and second wafer II present on first holding area 8 are grasped by means of the two grasping/retaining elements 12 of grasping apparatus 7. This is depicted in FIG. 6g.

In a fifth method step, grasping apparatus 7 thus loaded with the two wafers I and II is pivoted into the position shown in FIG. 6h, and places first wafer 1 on second holding area 9 and second wafer 1 on wafer processing station 3. In this method step the two wafers I and II being grasped are transported and placed simultaneously, so that the method proceeds very quickly.

In a sixth method step, grasping apparatus 7 with unoccupied grasping/retaining elements 12 is then pivoted back into the neutral position depicted in FIG. 6i.

In a seventh method step, robot arm 5 is raised out of its parked position beneath holding area 9, and first wafer I present on second holding area 9 is grasped. This step also requires very little time.

In an eighth method step, robot arm 5 then places first wafer I, picked up as described, back into a magazine 4 of wafer storage station 2, as depicted in FIG. 6i.

Subsequent thereto, the entire sequence of the method starts from the beginning with the first method step and the removal of a third wafer III. As the method steps are executed, second wafer II that is already located in the transport arrangement is automatically transported with grasping apparatus 7 from wafer processing station 3 to second holding area 9, picked up there by robot arm 5, and placed back into a magazine 4 of wafer storage station 2.

In an advantageous embodiment of the method according to the present invention, a pre-alignment of wafer I placed on first holding area 8 is performed respectively during the second method step and the sixth method step.

A transport arrangement embodied in this fashion is characterized in that, in particular because robot arm 5 is parked beneath second holding area 9, and because of the configuration of angle α between the two arms 10 of grasping apparatus 7 as 90<α<180°, throughput can be increased considerably, i.e. by more than 10%. The angular dimension selected for angle α results in a decrease in the pivoting time of grasping apparatus 7 from one position to the next.

### PARTS LIST

1 Wafers

2 Wafer storage station

3 Wafer processing station

4 Magazine

5 Robot arm

6 Guide

7 Grasping apparatus

8 First holding area

9 Second holding area

10 Arm

11 Vacuum suction device

12 Grasping/retaining device

13 Rotation point

14 Microscope

15 Eyepieces

16 Microscope stage

17 Monitor

I First wafer

II Second wafer

III Third wafer

α Angle

What is claimed is:

1. An apparatus for grasping and transporting wafers, comprising:
a two-armed grasping apparatus (7), pivotable about a central rotation point (13),
two grasping/retaining elements (12), each of them arranged at one of the two free ends of said two-armed grasping apparatus (7), whereby said grasping/retaining elements (12) are equipped with vacuum suction devices (11),
wherein the two arms (10) of the grasping apparatus (7) are angled with respect to one another at an angle (α) 90°<α<180°.

2. The apparatus as defined in claim 1, wherein the angle (α) between the two arms (10) of the grasping apparatus (7) equals 120°.

3. The apparatus as defined in claim 1, wherein the angle (α) between the two arms (10) of the grasping apparatus (7) equals 135°.

4. The apparatus as defined in claim 2, wherein the grasping apparatus (7) is pivotable back and forth about the rotation point (13) a maximum of 2×120° between two extreme excursion positions.

5. The apparatus as defined in claim 2, wherein the grasping apparatus (7) is pivotable back and forth about the rotation point (13) a maximum of 2×120° between two extreme excursion positions and wherein the end points of the respective pivot angle of the grasping apparatus (7) are bounded by stops.

6. The apparatus as defined in claim 3, wherein the grasping apparatus (7) is pivotable back and forth about the rotation point (13) a maximum of 135° between two extreme excursion positions.

7. The apparatus as defined in claim 3, wherein the grasping apparatus (7) is pivotable back and forth about the rotation point (13) a maximum of 135° between two extreme excursion positions and wherein the end points of the respective pivot angle of the grasping apparatus (7) are bounded by stops.

8. The apparatus as defined in claim 3, wherein starting from a neutral position, the grasping apparatus (7) is pivotable about the rotation point (13) a maximum of ½×135° back and forth.

9. The apparatus as defined in claim 3, wherein starting from a neutral position, the grasping apparatus (7) is pivotable about the rotation point (13) a maximum of ½×135° back and forth and wherein the end points of the respective pivot angle of the grasping apparatus (7) are bounded by stops.

10. The apparatus as defined in claim 1, wherein the grasping apparatus (7) is pivotable in unlimited fashion about the rotation point (13).

11. A transport arrangement for transporting wafers between two stations, in particular between a wafer magazine and a testing apparatus, comprising:
at least one wafer storage station (2),
a robot arm (5) for unloading and/or loading the wafer storage station (2),
a first holding area (8) for the wafers (1),
a wafer processing station (3),
a two-armed grasping apparatus (7) for transporting the wafers (1) from the holding area (8) to the wafer processing station (3) and back, whereby said grasping apparatus (7) is pivotable about a central rotation point (13) and comprises two grasping/retaining elements (12), each of them arranged at one of the two free ends of said two-armed grasping apparatus (7), whereby said grasping/retaining elements (12) are equipped with vacuum suction devices (11), whereby the two arms (10) of the grasping apparatus (7) are angled with respect to one another at an angle (α) 90°<α<180°,
and a second holding area (9) between the wafer storage station (2) and the wafer processing station (3), the one holding area (8) serving as a depository for transport to the wafer processing station (3) and the other holding area (9) serving as depository for transport back from the wafer processing station (3).

12. The transport arrangement as defined in claim 11, wherein the first holding area (8) serving for transport to the wafer processing station (3) is configured as a pre-alignment station.

13. The transport arrangement as defined in claim 11, wherein the two holding areas (8, 9) are arranged relative to the rotation point (13) of the grasping apparatus (7) at an angle (a) defined by the two arms (10) of the grasping apparatus (7), and on a pivot circle defined by the ends of the two arms (10).

14. The transport arrangement as defined in claim 12, wherein the two holding areas (8, 9) are arranged relative to the rotation point (13) of the grasping apparatus (7) at an angle (α) defined by the two arms (10) of the grasping apparatus (7), and on a pivot circle defined by the ends of the two arms (10).

15. A method for transporting wafers between two stations, in particular between a wafer magazine and a testing apparatus, by means of a transport arrangement as defined in claim 13, comprising the steps of:
a) removing a first wafer (I) from a wafer storage station (2) and placing said first wafer (I) on a first holding area (8) by means of a robot arm (5);
b) grasping the first wafer (I) present on the first holding area (8) by means of a grasping apparatus (7) and transferring said first wafer (I) to a wafer processing station (3), and pivoting the grasping apparatus (7) into a neutral position while removal of a second wafer (II) from the wafer storage station (3) is simultaneously accomplished;
c) placing the second wafer (II) on the first holding area (8) by means of the robot arm (5);
d) moving the robot arm (5) into a parked position beneath the second holding area (9) and simultaneously grasping the first wafer (I) placed on the wafer processing station (3) and the second wafer (II) placed on the first holding area (8) by means of the grasping apparatus (7);
e) placing the first wafer (I) on a second holding area (9) and placing the second wafer (II) on the wafer processing station (3);
f) pivoting the grasping apparatus (7) into a neutral position;
g) grasping the first wafer (I) that was placed on the second holding area (9), by raising the robot arm (5) parked beneath the second holding area (9); and
h) placing in the wafer storage station (2) the first wafer (I) picked up from the second holding area (9).

16. The method as defined in claim 15, the first holding area (8) being configured as a pre-alignment station, wherein a pre-alignment of each wafer (1) placed on the first holding area (8) is accomplished each time between method steps a) and b).

17. The method as defined in claim 15, the first holding area (8) being configured as a pre-alignment station, wherein a pre-alignment of the wafers (1) placed on the first holding area (8) is accomplished each time during method step d).
